(19) United States
(12) Patent Application Publication
(10) Pub. No.: US 2004/0206941 A1
(43) Pub. Date: Oct. 21, 2004

(54) Composition for enhancing conductivity of a carrier medium and method of use thereof

(76) Inventor: Michael H. Gurin, Glenview, IL (US)

Correspondence Address: Michael Gurin, Unit A, 4132 Cove Lane, Glenview, IL, 60025, US

(21) Appl. No.: 10/603,332

(22) Filed: Jun. 26, 2003

Related U.S. Application Data
(63) Continuation-in-part of application No. 09/721,074, filed on Nov. 22, 2000, now Pat. No. 6,432,320.
(63) Continuation-in-part of application No. PCT/US01/49758, filed on Dec. 20, 2001.
(60) Provisional application No. 60/391,601, filed on Jun. 27, 2002.

(51) Int. Cl. H01B 1/00

(52) U.S. Cl. 252/500

(57) ABSTRACT

A composition and method for enhancing the electrical and thermal conductivity. The composition comprises a powder having average particle sizes in the nanometer to micron size range, a coating for imparting corrosion resistance and/or acting as a dispersant, and a transfer medium. The transfer medium is selected from the group of interpolymers, polymers, gaseous and liquid fluids, and phase change materials. Suitable powders include metals and metal oxides, alloys or blends thereof, and carbon derivatives. The surface of the powder is modified by surface complexation or physical adsorption by a coating compound. The coated powder, when mixed with a transfer medium, forms a colloidal dispersion which exhibits enhanced heat transfer capacity, and electrical and thermal conductivity, stable chemical composition, faster heat transfer rates, and dispersion maintenance which are beneficial to most thermal or electrical transfer systems.

### CROSS-REFERENCE TO RELATED APPLICATIONS

This application claims priority from U.S. Provisional Patent Application Serial No. 60/391,601 filed Jun. 27, 2002 and entitled COMPOSITION for ENHANCING CONDUCTIVITY of a CARRIER MEDIUM AND METHOD OF USE and is continuation-in-part of U.S. patent Ser. No. 09/721,074 filed Nov. 22, 2000 and PCT/US01/49758.

### BACKGROUND OF THE INVENTION

The present invention relates to compositions and methods for enhancing the thermal conductivity, coefficient of thermal heat transfer, electrical conductivity in a carrier medium. More particularly, the present invention pertains to a composition including stabilized nano-particulate metal powders employed to enhance the thermal capacity and thermal and electrical conductivity of carrier media.

Heat transfer compositions have applications in both heating and cooling, including refrigeration, air conditioning, computer processors, thermal storage systems, heating pipes, fuel cells, and hot water and steam systems. Heat transfer compositions include a wide range of solids, liquids or phase change materials and the like. For example, liquid or phase change heat transfer materials include water, aqueous brines, alcohols, glycols, ammonia, hydrocarbons, ethers, and various halogen derivatives of these materials, such as chlorofluorocarbons (CFCs), hydrochlorofluorocarbons (HCFCs), and the like. Additives, such as refrigerant oil additives for lubrication and composites of fluids to affect boiling or freezing temperature, have been included in the fluid or phase change materials. Thermal transfer compositions made of solids have been used alone or in combination with additives, such as metal and carbon additives as polymer matrixes for enhanced thermal conductivity. Such media are used to transfer heat from one body to another, typically from a heat source (e.g., an vehicle engine, boiler, computer chip, or refrigerator), to a heat sink, to effect cooling of the heat source, heating of the heat sink, or to remove unwanted heat generated by the heat source. Heat transfer media provide thermal pathways between a heat source and a heat sink that dissipates the thermal energy. Thermal transfer media may also be integrated into flow systems, such as to improve heat flow or transfer thermal energy to a fluid flow system such as in a radiant heating system.

Several criteria have been used for selecting heat transfer media for specific applications. Exemplary criteria include the influence of temperature on heat transfer capacity and viscosity, and the energy required to maintain an integral flow system through a heat transfer system. Specific parameters describing the comparative performance of a heat transfer medium are density, thermal conductivity, specific heat, and electrical conductivity. The maximization of the heat transfer capability of any heat transfer system is important to the overall energy efficiency, material resource minimization, and system costs. There are numerous improvements in heat transfer systems that are further enhanced by increased thermal capacity. One example is the utilization of polymers suitable for standard plastic production processes such as injection molding, film forming and die-casting. Plastic production techniques are more cost effective, have a reduced total manufactured cost and weight, require a reduced labor component, and typically have lower assembly costs.

Other factors that affect the feasibility and performance of heat transfer media include environmental impact, toxicity, flammability, physical state at normal operating temperature, and corrosive nature.

A variety of materials can be used as heat transfer media in systems where heat transfer efficiency is to be maximized and fluid flow transport energy minimized. Such media can benefit from cost effective methods to enhance thermal conductivity. The heat transfer media may include a filler material that is thermally conductive to enhance the thermal conductivity of the heat transfer medium. Expensive materials size as nanotubes, graphite fillers, and micron-sized metal powders have been used in polymers. However, fillers tend to impart stresses between component types during thermal cycling.

The present invention provides a new and improved thermal conductivity enhancement composition for heat transfer compositions and method of use.

Electrical conductivity compositions are utilized in a wide range of applications including, though not limited to: conductive inks, circuit boards, paints, electromagnetic and radio frequency interference protective coatings, and antennas. Electrical conductivity compositions include a wide range of solids and liquids. For example, conductive polymers doped with metallic fillings. Electrically conductive media provide electron pathways between an electrical source and sink, respectively cathode and anode, to transfer electrical energy.

Several criteria for selecting electrical conductivity media include resistance and capacitance. Other factors that affect the feasibility and performance of conductive media include environmental impact, toxicity, flammability, physical state at normal operating temperature, and corrosive nature.

A variety of materials can be used as electrically conductive media in systems where electrical (electron) is to be maximized and resistance is minimized. Such media can benefit from cost effective methods to enhance electrical conductivity. The electrically conductive media may include a filler material that is electrically conductive to enhance the conductivity of the carrier medium. Expensive materials size as nanotubes, graphite fillers, and micron-sized metal powders have been used in polymers. However, fillers tend to impart stresses between component types during thermal cycling.

### SUMMARY OF THE INVENTION

In accordance with one aspect of the present invention, a enhanced conductivity composition is provided that includes a carrier media and a corrosion-resistant powder. It is a further aspect of the invention that the corrosion-resistant powder has a coating that imparts a corrosion resistance property to the powder and/or enhances dispersion of the powder in the carrier media.

In accordance with another aspect of the present invention, there is provided a coated compound for incorporation into a carrier medium. The coated compound comprises a powder selected from the group consisting of metals, metal alloys, metallic compounds, and carbon, with the powder having nanometer-sized particles. It is another aspect of the invention that the powder be chemically stabilized with a corrosion inhibitor and/or a dispersant, such as an azole.

In accordance with another aspect of the present invention, a process for transferring heat between a heat source and a heat sink is provided. The process includes transferring heat between the heat source and the heat sink with a heat transfer composition that includes a powder. The powder has a surface thereof coated with a coating compound that provides the powder with improved corrosion resistance or dispersion characteristics as compared with an uncoated powder.

As used herein, the term heat transfer is used to imply the transfer of heat from a heat source to a heat sink, and applies to both heating and cooling (e.g., refrigeration) systems.

The term “primary loop” refers to the heat transfer method used in a primary refrigeration system, boiler system, or any other system that is directly affected by an energy transfer mechanism. This includes a compressor in a refrigeration system, combustion source in a boiler system, or a heat transfer fluid in an absorption system.

The term “secondary loop” refers to the path over which a heat transfer medium travels while it is being cycled between a heat source and a primary system, boiler system, or any other system that is indirectly affected by an energy transfer mechanism. This includes a shell and tube or plate heat exchanger in a refrigeration system or in a boiler system. The loop refers to the path over which the heat transfer medium travels while it is being cycled between the heat source and the primary system. Thus, for example, a secondary loop refrigeration system uses a heat transfer medium to transport energy from a heat source to a primary refrigeration system.

In accordance with another aspect of the present invention, a process for transferring electrons between a cathode and an anode is provided. The process includes transferring electrons between the cathode and the anode with an enhanced conductivity composition that includes a powder. The powder has a surface thereof coated with a coating compound that provides the powder with improved corrosion resistance or dispersion characteristics as compared with an uncoated powder.

As used herein, the term electron transfer is used to imply the flow of electrons from a cathode to anode.

The terms “carrier medium” or “carrier media,” as used herein, includes gaseous and liquid fluids, solids, semi-solids, liquids, and phase change heat transfer materials which don't flow at the operating temperature of a heat transfer system, and includes materials which may be solid at room temperature, but that undergo a phase transition at the operating temperature of the system.

The term “nanometer-sized particle,” or similar terms, as used herein, includes particles that have an average size of up to 2000 nm.

The term “phase change material” as used herein, is a material that undergoes a phase change, typically between the liquid and solid phases. Phase change materials are frequently used in energy storage applications because larger amounts of energy can be stored as latent heat, i.e., the energy released by solidification or required for liquefaction, than as sensible heat, i.e., the energy needed to increase the temperature of a single phase material.

One advantage of the present invention is that the thermal and electrical conductivity, thermal capacity, electrical capacitance and energy efficiency of host carrier medium are increased.

Another advantage of the present invention is that resources may be reduced by utilizing standard plastic and sintering production processes.

Yet another advantage of the present invention is that the coated compound is readily dispersed in the carrier medium.

A further advantage of the present invention derives from stabilization and passivation of the coated compound, enabling direct immersion into corrosive environments.

A yet further advantage of the invention is that the coated compound may maintain a mobile colloidal dispersion within the phase change material, enabling the coated compound to be utilized without the use of dispersion enhancement devices in a host carrier system.

A still further advantage of the present invention is that design flexibility of plastic parts is significantly greater than metal parts.

A yet further advantage of the present invention is stronger adhesion strength when non-matching coefficients of thermal expansion of material components exist.

A still further advantage of the present invention is reduced interfacial stress between the material components to enable higher loadings, and increased thermal and electrical conductivity.

Other advantages of the present invention derive from the enhanced thermal capacity of the heat transfer composition, which results in energy consumption reductions by reducing the incoming fluid temperature (in a cooling system) needed to achieve a targeted fluid leaving temperature. Reductions in fluid velocities may also be achieved, thereby reducing friction losses and pressure losses within a circulation pump.

A further advantage of the present invention is that by enabling stabilizing pure metals or their alloys to be used in a heat transfer system, heat transfer compositions with higher thermal transfer properties may be achieved as compared with compositions using oxidized forms of the metals or alloys.

Yet another advantage of the present invention is that the heat transfer coated compound is compatible with a wide range of heat transfer media, including, but not limited to media for applications ranging from engine cooling, heating, air conditioning, refrigeration, thermal storage, and in heat pipes, fuel cells, battery systems, hot water and steam systems, and microprocessor cooling systems.

Other advantages of the present invention derive from the enhanced electrical capacitance of the enhanced conductivity transfer composition, which results in energy consumption reductions by reducing the electrical current needed to achieve a targeted source of electrons. Reductions in electrical current may also be achieved, thereby reducing resistance losses and voltage losses and subsequent temperature rise.

A further advantage of the present invention is that by enabling stabilizing pure metals or their alloys to be used in an electrically conductive system, enhanced conductivity compositions with higher electron transfer properties may be achieved as compared with compositions using oxidized forms of the metals or alloys.

Yet another advantage of the present invention is that the heat transfer coated compound is compatible with a wide range of carrier media, including, but not limited to media for applications ranging from circuit boards, conductive inks, electromagnetic and radio frequency protective coatings, fuel cells, battery systems, and paints.

Additional features and advantages of the present invention are described in and will be apparent from the detailed description of the presently preferred embodiments. It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

### DETAILED DESCRIPTION OF THE PREFERRED EMBODIMENTS

A thermal and electrical conductivity enhancement compositions and methods for comprising a combination of a powder having average particle size in the nanometer to micron size range, a coating for the powder particles that functions to enhance corrosion resistance of the particles or disperses the powder in a carrier medium. The carrier medium is preferably selected from the group consisting of interpolymers, polymers, and phase change materials. When used in a conductivity enhancement system, the present invention offers a number of advantages, including increased thermal capacity, electrical capacitance, increased heat transfer rate, reduced electrical resistance, superior design flexibility and providing long and stable performance.

The nanometer-particle to micron-particle size powders, hereinafter referred to as “powder”, useful in this invention are those of metals and/or carbon derivatives. The powder may be a finely ground or otherwise comminuted solid or a crystalline solid. For example, ball milling or other suitable process may be used to form a fine powder.

The preferred particle size is influenced by a number of factors, including cost effectiveness, dispersion and settling characteristics (smaller particles tend to settle more slowly and re-disperse more quickly). Preferred powders have an average particle size (expressed in terms of the number average value of the largest dimension perpendicular to the longest dimension of the particle) of from about 1 nanometer and 100 microns. More preferred powders have a particle size of from about 10 nanometers (nm) to about 2000 nm. Particularly preferred powders have a particle size of from about 25 nanometers to about 1000 nm. Above about 1000 nm, the particles tend to maintain dispersions for shorter time than may be desirable for some applications. Within the preferred range, some of the particles may form aggregates or clusters having an average width of from about 50 nm to 1000 nm.

Preferred materials for forming the powder have a high heat transfer coefficient, high thermal conductivity per unit weight of the material, and low electrical resistance. The powder may be a powdered metal, powdered alloy, powdered compound of a metal, powdered carbon, powdered carbon compound, or combinations thereof. Exemplary metal-based powders include, for example, those of copper, aluminum, titanium, nickel, beryllium, silver, gold, or iron, alloys or blends, or compounds thereof. Copper and beryllium are particularly preferred metals for forming the powder, copper metal being particularly preferred. Exemplary carbon-based powders include those of graphite, carbon nanotubes, diamond, fullerene carbons of the general formula (C₂)ₙ, where n is an integer of at least 30, or blends thereof.

The powder is chemically or physically altered by association with a coating compound, for example, by surface interactions to form complexes between the powder particles and the coating compound or physical adsorption of a coating compound on the surface of the powder particles. The coating compound is preferably one that stabilizes and/or passivates the powder, providing corrosion resistance. This provides stabilization and passivation of the coated compound over a wide temperature range and in a wide variety of potentially corrosive environments. Improved redispersion, increased settling time, reduced clumping, and long-term stability of the host powder, may also result from the presence of the coating compound, as compared with a similar powder without the coating compound. While the exact cause of some of these improvements is not fully understood, it is speculated that the coating compound controls hydrophobic, hydrophilic, and molecular polarity properties of the powder, thus affecting settling time and redispersion time. The coating compound also allows the use of pure, or relatively pure metals which are usually prone to corrosion, rather than their oxides. Thus, copper metal powder may be used in place of copper oxide, resulting in enhanced thermal and electrical conductivity.

The coating compound preferably acts as a coating for the particles, residing primarily on the surface of the particles. It will be appreciated that the coating comprising the coating compound of the present invention is not merely an oxidized layer of the metal powder, such as a layer of copper oxide on a copper powder formed by oxidation of the copper surface.

For the coating compound, corrosion inhibitors and/or metal film coatings may be used. Exemplary coating compound include azoles and their substituted derivatives, particularly aromatic azoles (including diazoles, triazoles, and tetrazoles), such as benzotriazole, tolyltriazole, 2,5-(aminopentyl) benzimidazole, alkoxybenzotriazole, imidazoles, such as oleyl imidazoline, thiazoles, such as mercaptobenzothiazole, 1-phenyl-5-mercaptotetrazole, thiodiazoles, halogen-resistant azoles, and combinations thereof. Examples of halogen-resistant azoles include 5,6-dimethyl-benzotriazole; 5,6-diphenylbenzotriazole; 5-benzoyl-benzotriazole; 5-benzyl-benzotriazole and 5-phenyl-benzotriazole. Alkyl-substituted aromatic triazoles, such as tolyltriazole are particularly preferred. Azoles are particularly useful with copper-containing powders, such as pure copper or copper alloys, e.g. brass, but also have application with other metal-based powders, such as those formed from aluminum, steel, silver, and their alloys.

Other suitable coating compounds include inorganic corrosion inhibitors, including, but not limited to water-soluble amine salts, phosphates, and salts of transition elements, such as chromate salts. These coating compounds may also be used in combination with other corrosion inhibitors, such as azoles, to provide a “self heal” function. Lignin-based coating compound may also be used, in particular with carbon-based powders.

Ethylene oxide/propylene oxide (EO/PO) block copolymers may also be used as coating compound. Surfactants, such as anionic and nonionic surfactants, may also be used as coating compound, particularly for carbon. Exemplary anionic surfactants include calcium salts of alkylbenzenesulfonates. Exemplary nonionic surfactants include polyoxyalkylene alkyl ethers and polyoxyethylene/polyoxypropylene polymers.

Tolyltriazole is a particularly effective coating compound for copper. One preferred nano-particle size powder includes copper powder to which tolyltriazole is applied at from about 1-5% by weight. For aluminum and its alloys, cerium-based coating compound may be used. For example, an aqueous cerium non-halide solution is first applied to the powder, followed by contacting the treated surface with an aqueous cerium halide solution. For copper and silver particles, in particular, thiodiazoles substituted on the ring by a mercapto group and/or an amino group and triazoles substituted by a mercapto group and/or an amino group are effective. These compounds form a film on the particles. Oleyl imidazoline is particularly effective for steel. Ferrous and copper alloys can benefit from coating compound corrosion inhibitors sold under the trademark TRIM, available from Master Chemical Corporation of Toledo, Ohio that include triethanolamine and monoethanolamine.

Combinations of two or more azoles may be particularly effective, such as a combination of alkoxybenzotriazole, mercaptobenzothiazole, tolyltriazole, benzotriazole, a substituted benzotriazole, and/or 1-phenyl-5-mercaptotetrazole. Another combination, which is particularly effective for metallic surfaces, is a mixture of a pentane-soluble imidazoline, a pentane-soluble amide, a pyridine-based compound, a pentane-soluble dispersant, and a solvent.

Other corrosion inhibitors/passivating agents may be used which result in passivation of the powder and/or achieve a desirable effect on dispersion and redispersion.

For carbon-containing powders, such as graphite, carbon nanotubes, or blends of these carbon derivatives, suitable coating compounds, include lignin and its derivatives. In the paper making industry, lignin may be recovered as a by-product of the cellulose product. Depending on conditions under which the lignin is precipitated, the precipitated lignin may be either in the form of free acid lignin or a lignin salt. A monovalent salt of lignin, such as an alkali metal salt or an ammonium salt, is soluble in water, whereas free acid lignin and polyvalent metal salts of lignin are insoluble in water. In the case of carbon-based powders, the chemical additive tends to act as a dispersant, rather than as a corrosion inhibitor/passivation agent.

Other coating compound particularly useful with carbon-based powders include alkali metal salts, alkali earth metal salts, ammonium salts, alkyl ether phosphates, solvents, butyl ether and other surfactants, and the like.

The lignin-based compounds may be used alone or in combination with other coating compounds. Lignin sulfonic acid, alkali metal salts of lignin sulfonic acid, alkaline earth metal salts of lignin sulfonic acid, and ammonium salts of lignin sulfonic acid act as an anionic, surfactant-like component.

Such lignin-based compounds can be present in the coating compound either individually or in the form of mixtures of two or more compounds. For example, lignin sulfonic acid and/or alkali metal, alkaline earth metal and/or ammonium salts and one or more alkyl ether phosphates are effective coating compounds for carbon-based powders. Storage stable, low viscosity dispersants can also be made by replacing 10-25% of the submicron lignin with an acrylic resin, a rosin resin, a styrene-maleic anhydride copolymer resin, or a combination thereof. These are effective coating compounds for carbon-based powders, in particular. For example, the coating compound may include a lignin sulfonic acid and /or an alkali metal, alkaline earth metal, or ammonium salt. Other suitable combinations include a mixture of aminoethylated lignin and a sulfonated lignin.

While not fully understood, it is thought that lignin-based compounds reduce the interfacial tension between the carbon particles and the aqueous phase in order to wet the surface of the carbon particles.

As is apparent, the choice of a preferred coating compound may depend not only on the material from which the powder is formed, but also on the chemical environment, for example, whether the heat transfer medium is generally hydrophobic or hydrophilic, the desirability of reducing friction losses in the operating system in which the composition is to be used, and the desirability of maintaining a long term dispersion within the enhanced conductivity composition.

For example, in compositions where a high chemical resistance is desired, a neutral or alkaline azole, such as 2,5-(aminopentyl) benzimidazole may be used as the coating compound. Hydrophobic additives tend to maintain superior dispersions when the carrier medium is significantly hydrophobic. Hydrophilic additives tend to maintain superior dispersions when the carrier medium composition is significantly hydrophilic.

While the exact process by which dispersion is improved and maintained by the coating compound is not known, it is thought that organic corrosion inhibitors, such as heterocyclics react with the metal powder surface to form an organometallic complex. This takes the form of at least one, preferably several monolayers on the surface of the particle. The corrosion inhibitive action of such coating compounds upon the metal powder is manifest even at molecular layer dimensions, while unexpectedly achieving enhanced dispersion of the coated compound in the carrier medium. While aromatic azoles are believed to bond directly to the metal surface to produce an inhibiting complex, other surface interactions which result in a modification of the surface resulting in improved dispersion and/or passivation are also contemplated.

One or more of such coated powders may be used in combination with a carrier medium.

In addition to a coating compound, a suitable solvent may also be used. Common solvents may be used for this purpose.

In addition to a coating compound, suitable antioxidants, heat stabilizers and UV stabilizer, lubricants and mold release agents, colorants, such as dyes and pigments, fibrous and pulverulent fillers and reinforcing agents, nucleating agents and plasticizers may also be used. Common stabilizers and antioxidants, heat stabilizers and UV stabilizer, lubricants and mold release agents, colorants, such as dyes and pigments, fibrous and pulverulent fillers and reinforcing agents, nucleating agents and plasticizers may be used for this purpose. Such additives are used in the conventional effective amounts. The antioxidants and heat stabilizers which can be added to the thermoplastic materials according to the invention include those which are generally added to polymers, such as halides of metals of group I of the periodic table, e.g. sodium halides, potassium halides and lithium halides, in conjunction with copper(I) halides, e.g. the chloride, bromide or iodide. Other suitable stabilizers are sterically hindered phenols, hydroquinones, variously substituted members of this group and combinations of these, in concentrations of up to 1% by weight, based on the weight of the mixture. Suitable UV stabilizers are likewise those that are generally added to polymers, these stabilizers being employed in amounts of up to 2% by weight, base on the mixture. Examples of UV stabilizers are variously substituted resorcinols, salicylates, benzotriazoles, benzophenones, etc. Suitable lubricants and mold release agents, which may be added, for example, in amounts of up to 1% by weight, based on thermoplastic material, are stearic acids, stearyl alcohol, stearates and stearamides. Organic dyes, such as nigrosine, and pigments, e.g. titanium dioxide, cadmium sulfide, cadmium sulfide selenide, phthalocyanines, ultramarine blue or carbon black, may also be added. Moreover, the novel molding materials may contain fibrous and pulverulent fillers and reinforcing agents, such as carbon fibers, glass fibers, amorphous silica, asbestos, calcium silicate, calcium metasilicate, aluminum silicate, magnesium carbonate, kaolin, chalk, quartz powder, mica or feldspar, in amounts of up to 50% by weight, based on the molding material. Nucleating agents, such as talc, calcium fluoride, sodium phenylphosphinate, alumina or finely divided polytetrafluoroethylene, may also be used, in amounts of, for example, up to 5% by weight, based on material. Plasticizers, such as dioctyl phthalate, dibenzyl phthalate, butylbenzyl phthalate, hydrocarbon oils, N-n-butylbenzenesulfonamide and o- and p-tolueneethylsulfonamide are advantageously added in amounts of up to about tolueneethylsulfonamide 20% by weight, based on the molding material. Colorants, such as dyes and pigments, can be added in amounts of up to about tolueneethylsulfonamide 5% by weight, based on the molding material.

The composition may further include a prestabilized filler to further enhance the effectiveness of the surface modification. For example a material that will inhibit oxidation of the particle, for example, a noble metal, such as gold or silver, with or without a fatty acid may be used as pre-stabilized filler in combination with powder particles treated with one of the coating compounds described above. One or more of such fillers may be used in combination with a carrier medium.

The treated powder formed by treating the powder with a coating compound as described above may include an optional further functionalization agent, such as a treatment with polytetrafluoroethylene (PTFE, sold under the trademark TEFLON by E. I. Du Pont de Nemours and Co., Wilmington, Del.). Such functionalization may be carried out by solvent polymerization of copolymers containing monomer units useful as coating additives. The tolyltriazole, or other azole used as the coating compound, may be functionalized prior to mixing with the powder. Such PTFE-functionalized azoles are commercially available.

Such functionalization agents tend to reduce the coefficient of friction associated with the treated powder. Less polar fluids, such as alcohols and alkylglycols, which add hydrophobic characteristics that enhance the coated powders dispersion, within the medium, may also be used as functionalization agents. Functionalization agents may also be used to accelerate the re-dispersion time of the coated compound in the enhanced conductivity composition. Functionalization agents that provide surface modification or functional group substitution may also be used. Other benefits of certain functionalization agents include a reduction or elimination of mixing mechanisms and lower friction that enables reduced horsepower. The functionalized treated powder may enable the reduction of surfactants and dispersants to enhance further the thermal and electrical conductivity of carrier systems.

Other functionalization agents may be used to increase control of hydrophobic, hydrophilic, and molecular polarity qualities associated with treated metal powders.

The enhanced conductivity composition may further comprise additives, such as surfactants to reduce further the interfacial tension between the components. The interface between components typically contains voids and airspace that detracts from higher heat transfer coefficients and electrical resistance. For example, co-corrosion inhibitors selected from the group of aromatic acids and naphthenic acids, which acids have the free acid form or the alkaline, alkaline earth, ammonium and/or amine salt form may be used. Sodium benzoate, however, is generally not suitable.

The composition may further include additives, such as traditional dispersants to maintain superior dispersions within the carrier medium. For example, a low molecular weight dispersant may be applied as a coating to the powder and having a polar group with an affinity for the carrier media. Hydrophobic dispersants will maintain superior dispersions when the carrier media is significantly hydrophobic. Hydrophilic dispersants will maintain superior dispersions when the carrier media is significantly hydrophilic. The composition may further include materials that reduce the surface friction between the coated powder and any surfaces in the enhanced conductivity systems.

The stabilized nano-particle to micron-particle size powder provides increased operational energy efficiencies to the carrier medium through its enhanced thermal capacity, reduced electrical resistance, and enhanced electrical capacitance. The enhanced conductivity composition also reduces the need for dispersal mechanisms in phase change systems. The enhanced conductivity composition exhibits slow settling and soft settling characteristics and maintains a colloidal dispersion, as compared with conventional conductivity enhancement additives. This enables enhanced conductivity systems to operate with higher energy efficiencies through utilizing of said enhanced conductivity composition.

The carrier medium preferably has a high heat transfer capacity, high thermal loading capacity, low electrical resistance and long-term thermal and chemical stability throughout the range over which the composition is to be operated. Suitable carrier media include solids, gaseous and liquid fluids and phase change materials. These types of carrier media include, for example, fluids that are gaseous under atmospheric pressure but are liquid or semi-liquid under the ambient operating conditions of the conductivity system, and viscous fluids. Phase change materials are those that change from one phase, such as a solid, to a flowable material, such as a liquid or viscous fluid, at the operating temperature of the composition.

Additives may be employed in combination with a variety of carrier media. For example, additives may be included in water or other aqueous systems, such as, for example, aqueous brines (e.g., sodium or potassium chloride solution, sodium or potassium bromide solution, and the like), and mixtures of water with alcohols, glycols, ammonia, and the like. Additives may also be included in organic-based systems, suitable media for these applications including materials such as hydrocarbons, mineral oils, natural and synthetic oils, fats, waxes, ethers, esters, glycols, and various halogen derivatives of these materials, such as CFCs, hydrochlorofluorocarbons (HCFCs), and the like. These carrier media may be used alone or in combination. Mixed organic and aqueous carrier media may also be used, such as a mixture of water and ethylene glycol. One preferred mixed carrier media includes ethylene glycol and water in a volume ratio of from about 5:1 to about 1:5.

Exemplary non-phase change materials include interpolymers prepared by polymerizing one or more alpha-olefin monomers with one or more vinylidene aromatic monomers and/or one or more hindered aliphatic or cycloaliphatic vinylidene monomers, and optionally with other polymerizable ethylenically unsaturated monomer(s).

Exemplary non-phase change materials include conjugated polymers, crystalline polymers, amorphous polymers, epoxies, resins, acrylics, polycarbonates, polyphenylene ethers, polyimides, polyesters, acrylonitrile-butadiene-styrene (ABS); polymers such as polyethylene, polypropylene, polyamides, polyesters, polycarbonates, polyphenylene oxide, polyphenylene sulphide, polyetherimide, polyetheretherketone, polyether ketone, polyimides, polyarylates, styrene, poly(tetramethylene oxide), poly(ethylene oxide), poly(butadiene), poly(isoprene), poly(hydrogenated butadiene), poly(hydrogenated isoprene), liquid crystal polymers, polycarbonate, polyamide-imide, copolyimides precursors, reinforced polyimide composites and laminates made from said polyimides, polyphenylated polynuclear aromatic diamines, fluorocarbon polymers, polyetherester elastomers, neoprene, polyurea, polyanhydride, chlorosulphonated polyethylene, and ethylene/propylene/diene (EPDM) elastomers, polyvinyl chloride, polyethylene terephthalate, polyvinylchloride, ABS, polystyrene, polymethylmethacrylate, polyurethane and high performance engineering plastics, polyacrylate, polymethacrylate, and polysiloxane, aromatic copolyimide, polyalpholefins, polythiophene, polyaniline, polypyrrole, polyacetylene, polyisocyanurates, their substituted derivatives and similar polymers. Such polymers may contain stabilizers, pigments, fillers and other additives known for use in polymer compositions. Using benzocyclobutene shows many promising benefits. In addition to many other advantages, such as its lower dielectric constant and good adhesion to copper, benzocyclobutene has the significant capability for producing a level surface over heavily patterned under-layers.

Further exemplary carrier medium include monomers that further include vinyl monomers such as styrene, vinyl pyridines, N-vinyl pyrrolidone, vinyl acetate, acrylonitrile, methyl vinyl ketone, methyl methacrylate, methyl acrylate, 2-hydroxyethyl methacrylate, 2-hydroxyethyl acrylate; polyols such as ethylene glycol, 1,6-hexane diol, and 1,4-cyclohexanedicarbinol; polyamines such as 1,6-hexadiamine and 4,4′-methylenebis (N-methylaniline); polycarboxylic acids such as adipic acid and phthalic acids; epoxides such as ethylene oxide, propylene oxide, and cyclohexene oxide; and lactams such as epsilon-caprolactam.

Further exemplary carrier medium include polymers that further include poly(alkylene glycols) such as poly(ethylene glycol) (PEG), and poly(propylene glycol) (PPG); vinyl polymers such as poly(styrene), poly(vinyl acetate), poly(vinylpyrrolidone), poly(vinylpyridine), and poly(methyl methacrylate); organic liquid-soluble polysaccharides or functionalized polysaccharides such as cellulose acetate; and crosslinked swellable polysaccharides and functionalized polysaccharides.

Exemplary phase change medium include salt-hydrates, organic eutectics, clathrate-hydrates, paraffins, hydrocarbons, Fischer-Tropsch hard waxes, and inorganic eutectic mixtures. Examples of these phase change materials include inorganic and organic salts, preferably ammonium and alkali and alkali earth metal salts, such as sulfates, halides, nitrates, hydrides, acetates, acetamides, perborates, phosphates, hydroxides, and carbonates of magnesium, potassium, sodium, and calcium, both hydrated and unhydrated, alone or in combination with these or other media components. Examples of these include potassium sulfate, potassium chloride, sodium sulfate, sodium chloride, sodium metaborate, sodium acetate, disodium hydrogen phosphate dodecahydrate, sodium hydroxide, sodium carbonate decahydrate, hydrated disodium phosphate, ammonium chloride, magnesium chloride, calcium chloride, calcium bromide hexahydrate, perlite embedded with hydrogenated calcium chloride, lithium hydride, and lithium nitrate trihydrate. Other suitable phase change media include acetamide, methyl fumarate, myristic acid, Glauber's salt, paraffin wax, fatty acids, methyl-esters, methyl palmitate, methyl stearate, mixtures of short-chain acids, capric and lauric acid, commercial coconut fatty acids, propane and methane and the like.

In secondary loop systems, preferred carrier media include glycols, such as ethylene glycol, water, poly-α-olefins, silicate esters, chlorofluoro carbon liquids sold under the tradename FLUORINERT, such as FC-70, manufactured by the 3M Company. Polyaromatic compounds may also be used, such as biphenyl, diphenyl oxide, 1,1 diphenyl ethane, hydrogenated terphenylquatraphenyl compounds, and mixtures thereof, and dibenzyl toluene. Eutectic mixtures of two or more compounds may also be used, such as a eutectic mixture sold under the tradename DOWTHERM A by Dow Chemical Co., which includes 73% diphenyl oxide and 27% biphenyl. Other preferred carrier media for secondary loop systems include mineral oils and waxes, such as naphthenic and paraffinic oils and waxes, particularly those specified for high temperature applications, natural fats an oils, such as tallow and castor oils, synthetic oils, such as polyol esters, polyolefin oils, polyether oils, and the like.

For primary loop systems, suitable carrier media include water, aqueous solutions, salts, CFCs, HCFCs, perfluorinated hydrofluorocarbons (PFCs), highly fluorinated hydrofluorocarbons (HFCs), hydrofluorocarbon ethers (HFEs), and combinations thereof. Azeotropic mixtures of carrier media may be used. Propane and other natural gases are also useful in some applications.

Exemplary primary loop media include salt-hydrates, organic eutectics, clathrate-hydrates, paraffins, hydrocarbons, Fischer-Tropsch hard waxes, and inorganic eutectic mixtures. Examples of these primary loop media include inorganic and organic salts, preferably ammonium and alkali and alkali earth metal salts, such as sulfates, halides, nitrates, hydrides, acetates, acetamides, perborates, phosphates, hydroxides, and carbonates of magnesium, potassium, sodium, and calcium, both hydrated and unhydrated, alone or in combination with these or other media components. Examples of these include potassium sulfate, potassium chloride, sodium sulfate, sodium chloride, sodium metaborate, sodium acetate, disodium hydrogen phosphate dodecahydrate, sodium hydroxide, sodium carbonate decahydrate, hydrated disodium phosphate, ammonium chloride, magnesium chloride, calcium chloride, calcium bromide hexahydrate, perlite embedded with hydrogenated calcium chloride, lithium hydride, and lithium nitrate trihydrate. Other suitable primary loop media include acetamide, methyl fumarate, myristic acid, Glauber's salt, paraffin wax, fatty acids, methyl-esters, methyl palmitate, methyl stearate, mixtures of short-chain acids, capric and lauric acid, commercial coconut fatty acids, propane and methane and the like.

Propylene glycol, mineral oil, other oils, petroleum derivatives, ammonia, and the like may also be used.

The selection of a preferred carrier medium is in part dependent on the operating temperature range, heat transfer effectiveness, electrical conductivity effectiveness, cost, viscosity within the operating temperature range, and environmental impact if the material is likely to leave the system.

The coated powder is particularly useful in combination with carrier medium that tend to be in corrosive environments, such as high humidity environments.

Alternatively, the thermal and electrical conductivity enhancement composition may be combined as a blend, solution, or other mixture (azeotropic or otherwise) with one or more other materials. Such other materials may include additives and substances used to alter the physical properties of the carrier medium.

In yet another embodiment, the thermal and electrical conductivity enhancement composition is supplied in concentrated form, together with one or more of the components of a carrier medium, for later combination with the remaining components. For example, all of the components of a thermal and electrical conductivity enhancement composition, including the enhanced conductivity powder composition, but with the exception of monomers, are combined and supplied as a concentrate. When needed, the concentrate is mixed or otherwise combined with monomers, other bulk material, or added to an existing system in which the thermal and electrical conductivity enhancement composition and/or other components of the heat transfer medium have become depleted over time.

For example, the chemical additive may be first combined with a suitable solvent in which the chemical additive is soluble. Heat may be applied, if desired, to effect solubilization. The powder is then added to the mixture and allowed to contact the powder and interact to form the treated powder. Other additives, such as functionalizing agents and surfactants may also be added to the mixture. Excess chemical additive may be removed by filtering the treated powder then washing the treated filtered powder in a suitable solvent, which may be the same solvent used to dissolve the chemical additive, or a different solvent. The washed or unwashed treated powder is then dried, either by air-drying or in an oven at a sufficient temperature to remove the solvent without deleteriously affecting the properties of the additive. Alternatively, for example, where the solvent is useful in carrier medium, the drying step may be avoided. In another alternative embodiment, the treated powder is filtered to remove the solvent and/or excess chemical additive. The optimal amount of the additive used depends on the particular application, the composition of the additive, and the host carrier medium's ability to maintain the additive as dispersion in the enhanced conductivity composition. The cost to benefit ratio in terms of increased energy efficiency may also be a factor in determining the preferred concentration. The additive may be present in the enhanced conductivity composition at a concentration of from about 1 to 99% by weight, more preferably from about 3-20% by weight, and most preferably, around 10% by weight.

The additives used in accordance with the present invention preferably maintain a colloidal dispersion, are not prone to gas phase change, and have a high heat transfer capacity and low electrical resistance with low viscosity over the entire intended operating range. Preferred additives are also nonflammable, environmentally friendly, non-toxic, and chemically stable. The additive exhibits compatibility with a wide range of carrier media and applications over a wide range of operating conditions. Additives formed according to the present invention exhibit effectiveness within both primary and secondary loop carrier media as dispersion and closed loop re-circulation is achieved in non-phase change and phase change processes. The carrier media additive may be used in a variety of applications, including engine cooling, air conditioning, refrigeration, thermal storage, heat pipes, fuel cells, batteries, circuit boards, inks, paints, and hot water and steam systems.

In yet another alternative embodiment, the coating compound is added to a mixture of the carrier medium and the powder. In this embodiment the coating compound still contacts the powder surface and modifies the surface properties, either by chemically modifying the surface, physical adsorption or some other form of interaction.

The optimal amount of the coated powder used depends on the particular application, the composition of the carrier medium, and the host carrier medium's ability to maintain the thermal and electrical conductivity enhancement composition as dispersion in the enhanced conductivity composition. The cost to benefit ratio in terms of increased energy efficiency may also be a factor in determining the preferred concentration. The coated powder may be present in the inventive enhanced conductivity composition at a concentration of from about 1 to 99% by weight, more preferably from about 3-90% by weight, and most preferably, around 30% by weight. Preferably, the coating compound is present in stoichiometric excess. By this, it is meant that the coating compound is present in sufficient amount to provide at least a monolayer of coverage over the available surface of the particles.

In yet another embodiment, the precursor powder has an average particle sizes in the nanometer to micron size range being produced by a process step selected from the group of solubilized, dispersed, emulsified, grinded, spray atomized and vaporized, whereby the precursor powder (prior to being coated, complexed, or adsorbed by coating material) is produced with the coating compound in situ. In this embodiment the coating compound is prepared by one process selected from the group of complexing a coating compound with powder particles, adsorbing a coating compound on surfaces of the powder particles, and imparting a metal coating onto surfaces of powder particles and subsequently complexing the metal coating with another coating. The precursor powder has coating imparted onto its surface while in a reaction medium selected from the group of solvents, fluids, monomers, interpolymers, polymers, and phase change materials.

The term microemulsions refers to the water in oil or oil in water emulsions whereby the micelle size is sub-micron.

The term sonochemistry refers to the utilization of ultrasonic acoustic energy to create cavitation that creates extreme instantaneous temperature and pressure conditions. Hydrodynamic cavitation is a variant of sonochemistry.

The term high frequency refers to switching frequencies from 1 KHz to 1 MHz.

The term ultrahigh frequency refers to switching frequencies from 1 MHz to 10 GHz.

The term pre-complexed refers to a coating compound having complexed onto the precursor powder prior to reduction of pre-cursor powder to its final state.

The term electrochemical refers to the utilization of electron flow to create a reduction/oxidation reaction. The cathode of an electrochemical cell is the electrode where reduction occurs. The anode is the electrode where oxidation occurs. Electrons flow in a closed circuit from the anode to the cathode.

The term electrodialysis refers to a process to move ions from one solution into another using an electrolytic cell. In its simplest form, the cell is separated into three compartments by appropriate ion-exchange membranes with electrodes placed in the two outer compartments, and all compartments are fed a carrier, such as seawater. As an electrical current is forced through the cell, anions will move from the central compartment through an anion-exchange membrane into the anode compartment and the cations will move through an cation-exchange membrane into the cathode compartment.

The term plasma processing refers to an arc thermal plasma reactor to vaporize coarse metal powders, typically with quenching taking place using a supersonic nozzle.

The term combustion synthesis refers to a process utilizing oxidizers and fuels to obtain decomposition products of the oxidizer and the fuel.

The term supercritical refers to a unique blend of gaseous and liquid states whereby the solubility of a solute in a solvent is increased.

The term voltage potential refers to the electrical voltage potential between anode and cathode.

The term electrolysis refers to a process that involves an anodic “counter” electrode, a metal goods substrate and an acidic, neutral or alkaline electrolyte.

The in situ complexing of coating compound on pre-complexed powder precursor particles is prepared by one of many widely known processes as selected by the group of:

1. microemulsions and chemical reduction of pre-complexed metal salts;

2. microemulsions and reduction of pre-complexed metal salts using sonochemistry;

3. sonochemistry using high or ultrahigh frequency acoustic wave generation of cavitation in reaction vessel for reduction of pre-complexed metal salts;

4. sonochemistry using high or ultrahigh frequency acoustic wave generation of cavitation onto plating surface through plating deposition by electrolysis of pre-complexed metal salts;

5. submicron atomization of pre-complexed metal salts in liquid carrier with in situ chemical reduction;

6. plasma processing of powder precursor with quenching in liquid carrier having pre-solubilized complexing coating compound;

7. combustion synthesis processing of powder precursor with quenching in liquid carrier having pre-solubilized complexing coating compound;

8. pre-complexed powder precursor dissolved in supercritical fluid with in situ chemical reduction; or

9. high pressure hydrogen chemical reduction reaction of powder precursor in liquid carrier having pre-solubilized complexing coating compound.

The in situ complexing of coating compound on pre-complexed powder precursor particles is also prepared by processes modified in novel methods as selected by the group of:

1. sonochemistry using high or ultrahigh frequency acoustic wave generation of cavitation onto plating surface through plating by electroless deposition of pre-complexed metal salts;

2. sonochemistry using high or ultrahigh frequency acoustic wave generation of cavitation onto plating surface through plating deposition by electrolysis of pre-complexed metal salts using high frequency electrical power source;

3. submicron atomization of pre-complexed metal salts in liquid carrier with in situ electrochemical reduction;

4. submicron atomization of pre-complexed metal salts in liquid carrier within vessel with voltage potential between atomizer and cathode;

5. pre-complexed powder precursor dissolved in supercritical fluid with in situ electrochemical reduction;

6. electrolysis of pre-complexed metal salts using high frequency electrical power source on anode and cathode;

7. electrolysis of pre-complexed metal salts using electrically conductive material selected from group of electrolyte or conductive polymer;

8. high pressure hydrogen chemical reduction reaction of powder precursor in liquid carrier having pre-solubilized complexing coating compound in combination with high or ultrahigh frequency acoustic wave generation of cavitation in reaction vessel;

9. high pressure hydrogen chemical reduction reaction of powder precursor in liquid carrier having pre-solubilized complexing coating compound in combination with high or ultrahigh frequency electromagnetic force generation in reaction vessel;

10. cryogenic embrittlement in combination with processes selected from the group of high pressure hydrogen embrittlement, or high|ultrahigh frequency acoustic wave generation of cavitation in reaction vessel; or

11. electrodialysis of pre-complexed metal salts in combination with processes selected from the group of high pressure hydrogen embrittlement, or high|ultrahigh frequency acoustic wave generation of cavitation on cathode.

Enhanced conductivity composition formed according to the present invention preferably maintain a colloidal dispersion throughout the production process, are not prone to gas phase change, and have a high heat transfer capacity and low electrical resistance over the entire intended operating range. Preferred enhanced conductivity compositions are also nonflammable, environmentally friendly, non-toxic, and chemically stable. The enhanced conductivity composition exhibits compatibility with a wide range of carrier medium and applications over a wide range of operating conditions.

The enhanced conductivity composition has application in a wide variety of heat transfer applications including, but not limited to heating and cooling, including refrigeration, air conditioning, computer processors, thermal storage systems, heating pipes, fuel cells, and hot water and steam systems. The enhanced thermal capacity heat transfer composition may be utilized in primary and or secondary heat transfer systems.

In primary heat transfer systems the heat transfer composition transfers heat between an energy source and a heat transfer medium by transferring energy from the energy source to the heat transfer composition.

In secondary heat transfer systems, the heat transfer composition transfers heat in a secondary loop, between a heat source and a heat sink by transferring heat from the heat source to the heat transfer composition and transferring the heat from the heat transfer medium to the heat sink.

The enhanced conductivity composition has application in a wide variety of electron flow applications including, but not limited to fuel cells, batteries, conductive inks and paints, circuit boards, capacitors and electrolyte systems. The enhanced conductivity composition may be utilized in primary and or secondary electron transfer systems.

In primary electron transfer systems the electrical flow of energy transfers electrons between a cathode and anode in a carrier medium by transferring energy directly through the enhanced conductivity composition.

In secondary electron transfer systems, the enhanced conductivity composition transfers electrons in a secondary loop, between a cathode and anode in a carrier medium by transferring energy through a electrolyte.

Without intending to limit the scope of the invention, the following example describes a method of forming and using the heat transfer compositions of the present invention.

### EXAMPLES

### Example 1

A composition was formed by using a copper powder comprising copper particles of average particle size of 50 nanometers. The powder was chemically modified with tolyltriazole by the following method. A solution of tolyltriazole (sold under the tradename COBRATEC TT 100, by PMC, Inc, of Sun Valley, Calif.) at 3% by weight of the copper powder, was dissolved in a volatile organic solvent comprising 2-butanone (also known as methyl ethyl ketone, MEK) and stirred on a magnetic stirring hot plate. Copper powder sold under the trade name Cu 110 by Atlantic Equipment Engineers (spherical 1-5 microns particle size) was reduced to a powder of an average particle size of 50 nanometers by a ball milling process. The resulting copper powder was slurried in the solution for about 15 minutes at a temperature of 50-55 C.

The coated product was isolated by filtration, washed once with solvent and then allowed to dry either in air or by oven drying. The product showed enhanced thermal transfer properties and dispersion characteristics when combined with heat transfer media as compared with an untreated copper powder.

The coated powders and high density polyethelyne (HDPE) resin were dry mixed in plastic bags with a copper coated powder a nominal weight fraction of 25%; the resulting compound has an average density of 1.22 g/cm³. It is estimated that powder residue adhering to the mixing bags reduces the copper powder weight fraction by one percent. The powder/resin mixtures were compounded in a brabender, single-screw extruder. The screw L/D ratio is 25:1 and the screw compression ratio is 3:1. The mixture was extruded at a screw speed of 65 rpm with an extrusion temperature 190° C. through a 6.35 mm rod die at a rate of approximately 30 g/min. After steady state extrusion of the neat resin was achieved, 450 g of the copper powder/HDPE mixture was introduced to the hopper. The extrudate changed from clear to dark brown in appearance and, after allowing approximately 3 residence times to pass, several 50 g masses of the extruded mixture were collected. The 50 g masses were pressed into plates having a nominal thickness of 3.05 mm in a press under a one ton load at 170° C. for 25 minutes, and then cooled to room temperature in approximately 20 minutes.

### Example 2

A heat transfer composition was formed by using a copper powder having an average particle size of 50 nm. The powder was chemically modified with tolyltriazole by dissolving 3% weight percent copper powder in a tolyltriazole solution (COBRATEC TT 100, by PMC, Inc, of Sun Valley, Calif.) with methyl ethyl ketone and stirred on a magnetic stirring hot plate. Copper powder sold under the trade name CU 110 by Atlantic Equipment Engineers (spherical 1-5 micron particle size) was reduced to a powder of an average particle size of 50 nanometers by a ball milling process. The resulting copper powder was slurried in the solution for about 15 minutes at a temperature of 50-55° C. The coated product was isolated by filtration, washed once with solvent and then allowed to dry either in air or by oven drying. The resulting product demonstrated enhanced thermal transfer properties and dispersion characteristics when combined with heat transfer media as compared with an untreated copper powder.

### Example 3

A microemulsion is created using the surfactant sodium bis(2-ethylhexyl) sulfosuccinate (known as AOT) in a blend of ethylene glycol, and copper(II) ammonia from spent etchant. The copper ions are pre-complexed with tolytriazole solubilized in ethylene glycol. Chemical reduction is obtained by using hydrazine following pH adjustment.

### Example 4

A microemulsion is created using the surfactant sodium bis(2-ethylhexyl) sulfosuccinate (known as AOT) in a blend of ethylene glycol, and copper(II) ammonia from spent etchant. The copper ions are pre-complexed with tolytriazole solubilized in ethylene glycol. Chemical reduction is obtained by using hydrazine following pH adjustment with simultaneous immersion of ultrasonic transducer to generate cavitation.

### Example 5

A blend of ethylene glycol, and copper(II) ammonia from spent etchant is mixed. The copper ions are pre-complexed with tolytriazole solubilized in ethylene glycol. Chemical reduction is obtained by using hydrazine following pH adjustment with simultaneous immersion of ultrasonic transducer to generate cavitation.

### Example 6

A blend of ethylene glycol, and copper(II) ammonia from spent etchant is mixed. The copper ions are pre-complexed with tolytriazole solubilized in ethylene glycol. A substrate is placed into the reaction vessel, whereby chemical reduction is obtained by using formaldehyde following pH adjustment to plate the substrate. Simultaneous utilization of ultrahigh frequency ultrasonic transducers to generate focused cavitation onto the substrate to remove deposited metals and create powders.

### Example 7

A blend of ethylene glycol, and copper(II) ammonia from spent etchant is mixed. The copper ions are pre-complexed with tolytriazole solubilized in ethylene glycol. A substrate (cathode) is placed into the reaction vessel, whereby a voltage potential is placed across cathode/anode. Simultaneous utilization of ultrahigh frequency ultrasonic transducers to generate focused cavitation onto the electroplated substrate to remove deposited metals and create powders.

### Example 8

A blend of ethylene glycol, and copper(II) ammonia from spent etchant is mixed. The copper ions are pre-complexed with tolytriazole solubilized in ethylene glycol. A substrate (cathode) is placed into the reaction vessel, whereby a high frequency voltage potential is placed across cathode/anode utilizing a high frequency switching power supply. Simultaneous utilization of ultrahigh frequency ultrasonic transducers to generate focused cavitation onto the electroplated substrate to remove deposited metals and create powders.

### Example 9

A blend of ethylene glycol, and copper(II) ammonia from spent etchant is mixed (stream #1). The copper ions are pre-complexed with tolytriazole solubilized in ethylene glycol. Chemical reduction is obtained by using hydrazine with pH adjustment (stream #2) for simultaneous spraying of atomized (submicron) individual streams #1 and #2.

### Example 10

A blend of ethylene glycol, and copper(II) ammonia from spent etchant is mixed (stream #1). The copper ions are pre-complexed with tolytriazole solubilized in ethylene glycol. Chemical reduction is obtained by using hydrazine with pH adjustment (stream #2) for simultaneous spraying of atomized (submicron) individual streams #1 and #2. A small voltage potential of 10 volts is placed between the spray atomizer and substrate.

### Example 11

A blend of ethylene glycol, and copper(II) ammonia from spent etchant is mixed (stream #1). The copper ions are pre-complexed with tolytriazole solubilized in ethylene glycol. Electrochemical reduction is obtained by placing a 100V voltage potential between the spray atomizer and substrate.

### Example 12

Coarse copper powder is plasma vaporized into a quenching liquid of ethylene glycol and tolytriazole. The produced submicron copper is complexed with the solubilized tolytriazole.

### Example 13

Coarse copper powder and liquid hydrogen is combusted with byproducts ejected into a quenching liquid of ethylene glycol and tolytriazole. The produced submicron copper is complexed with the solubilized tolytriazole.

### Example 14

Copper oxide is solubilized in supercritical carbon dioxide. Hydrazine, pH adjusted ethylene glycol and tolytriazole are then subsequently injected into supercritical solution. The produced submicron copper is complexed with the solubilized tolytriazole.

### Example 15

Copper oxide is solubilized in supercritical carbon dioxide. Hydrazine, pH adjusted ethylene glycol and tolytriazole are then subsequently injected into supercritical solution. A small voltage potential of 10 volts is placed between the reaction vessel and injected substrate that acts as anode.

### Example 16

A blend of ethylene glycol, and copper(II) ammonia from spent etchant is mixed. The copper ions are pre-complexed with tolytriazole solubilized in ethylene glycol. Standard electrolysis reduction is conducted with the exception of ultrahigh frequency power supply to yield copper nano-powder deposited on cathode substrate.

### Example 17

A blend of ethylene glycol, sodium chloride (as electrolyte) and copper(II) ammonia from spent etchant is mixed. The copper ions are pre-complexed with tolytriazole solubilized in ethylene glycol. Standard electrolysis reduction is conducted with the exception of ultrahigh frequency power supply, electrolyte, ionic membrane to yield copper nano-powder in situ.

### Example 18

A blend of ethylene glycol, and copper(II) ammonia from spent etchant is mixed. The copper ions are pre-complexed with tolytriazole solubilized in ethylene glycol. The contents are placed into a high pressure vessel in which hydrogen liquid is injected. Temperature is raised to achieve reduction of copper.

### Example 19

A blend of ethylene glycol, and copper(II) ammonia from spent etchant is mixed. The copper ions are pre-complexed with tolytriazole solubilized in ethylene glycol. The contents are placed into a high pressure vessel in which hydrogen liquid is injected. The simultaneous utilization of ultrahigh frequency ultrasonic transducers generates cavitation that raises instantaneous temperature and pressure thus achieving reduction of copper.

### Example 20

A blend of ethylene glycol, and copper(II) ammonia from spent etchant is mixed. The copper ions are pre-complexed with tolytriazole solubilized in ethylene glycol. The contents are placed into a high pressure vessel in which hydrogen liquid is injected. The simultaneous utilization of ultrahigh frequency electromagnetic generator maintains polarity flux during reduction of copper.

### Example 21

A blend of copper powder and cryogenic hydrogen is mixed. The mixture is circulated in a closed circuit pipe loop at high flow rates with alternating zones of ultrahigh frequency ultrasonic transducers to generate focused cavitation that raises instantaneous temperature and pressure thus achieving embrittlement cracks in the powder. The concurrent cryogenic embrittlement with known hydrogen embrittlement rapidly reduces powder particle size.

### Example 22

A blend of copper powder and cryogenic nitrogen is mixed. The mixture is circulated in a closed circuit pipe loop at high flow rates with alternating zones of ultrahigh frequency ultrasonic transducers to generate focused cavitation that raises instantaneous temperature and pressure thus achieving embrittlement cracks in the powder. The rapid changes from very high temperatures and pressures created by cavitation and subsequent return to cryogenic temperatures creates microscopic cracks thus rapidly reduces powder particle size.

### Example 23

A blend of ethylene glycol, and copper(II) ammonia from spent etchant is mixed. The copper ions are pre-complexed with tolytriazole solubilized in ethylene glycol. Electrodialysis is utilized to move the copper ions from the spent etchant solution into another using the electrolytic cell. In its simplest form, the cell is separated into three compartments by appropriate ion-exchange membranes with electrodes placed in the two outer compartments, and all compartments are fed a carrier, such as the blend of ethylene glycol, copper(II) ammonia, and tolytriazole. As an electrical current is forced through the cell, anions will move from the central compartment through an anion-exchange membrane into the anode compartment and the cations will move through an cation-exchange membrane into the cathode compartment. The cathode compartment is subjected to ultrahigh frequency ultrasonic transducers that generate cavitation in order to raise instantaneously temperature and pressure thus achieving reduction of copper.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1) A composition having enhanced thermal and electrical conductivity, comprising, in combination a:
powder having average particle sizes in the nanometer to micron size range;
coating imparted to the powder particles; and
carrier medium selected from the group of carrier fluids, monomers, interpolymers, polymers, and phase change materials.

2) The composition of claim 1, wherein the coating further comprises a coating capable of acting as at least one of imparting composition stabilization, corrosion resistance and acting as a dispersant.

3) The composition of claim 2, wherein the coating acts as dispersant of the powder in the carrier medium by at least one of increasing settling time of the powder, passivating the powder, reducing interfacial tension of the powder and increases adhesion to the powder.

4) A process for transferring heat between a heat source and a heat sink, comprising the step of interposing between the heat source and the heat sink a heat transfer composition comprising a surface-coated powder, the coating imparting improved thermal conductivity properties to the powder relative to uncoated powder.

5) The process of claim 4, further comprising including the step of suspending the coated powder in a heat transfer medium.

6) The process of claim 4, wherein the surface-coated powder is prepared by one of:
complexing a coating compound with powder particles;
adsorbing a coating compound on surfaces of the powder particles; and
imparting a metal coating onto surfaces of powder particles and subsequently complexing the metal coating with another coating.

7) The process of claim 4, wherein the coating compound is in sufficient amount to form at least a molecular monolayer of the coating compound on surfaces of the powder particles.

8) The composition of claim 1 wherein the powder further comprises an average particle size of less than 10 microns.

9) The composition of claim 8 wherein the powder further comprises an average particle size 30 within the range of 10 nm to 2μ.

10) The composition of claim 1 wherein the powder is selected from the group of metal, metal alloy, organic metal compounds, inorganic metal compounds, carbon and combinations thereof.

11) The composition of claim 10 wherein the powder is selected from the group of metals consisting of copper, titanium, nickel, beryllium, iron, silver, gold, alloys thereof, blends thereof, and compounds thereof.

12) The composition of claim 10 wherein the powder is selected from the group of carbons consisting of graphite, carbon nanotubes, diamond, fullerene carbons of the general formula (C₂)ₙ, where n is an integer of at least 30, and blends thereof.

13) The composition as claimed in claim 1 wherein the carrier medium is selected from the group consisting of solids, fluids, and phase change materials.

14) The composition as claimed in claim 1 wherein the carrier medium is an interpolymer.

15) The composition of claim 14 wherein the interpolymer is prepared by polymerizing alpha-olefin monomer with vinylidene aromatic monomer and aliphatic vinylidene monomers with a volume ratio between 10:1 to 1:100 and a weight percent of 99 to 1 percent.

16) The composition of claim 15 wherein the interpolymer is further prepared with polymerizable ethylenically unsaturated monomer.

17) The composition of claim 13 wherein carrier medium is selected from the group consisting of conjugated polymers, crystalline polymers, amorphous polymers, epoxies, resins, acrylics, polycarbonates, polyphenylene ethers, polyimides, polyesters, acrylonitrile-butadiene-styrene (ABS); polyethylene, polypropylene, polyamides, polyesters, polycarbonates, polyphenylene oxide, polyphenylene sulphide, polyetherimide, polyetheretherketone, polyether ketone, polyimides, polyarylates, styrene, poly(tetramethylene oxide), poly(ethylene oxide), poly(butadiene), poly(isoprene), poly(hydrogenated butadiene), poly(hydrogenated isoprene), liquid crystal polymers, polycarbonate, polyamide-imide, copolyimides precursors, reinforced polyimide composites and laminates made from said polyimides, polyphenylated polynuclear aromatic diamines, fluorocarbon polymers, polyetherester elastomers, neoprene, polyurea, polyanhydride, chlorosulphonated polyethylene, ethylene/propylene/diene (EPDM) elastomers, polyvinyl chloride, polyethylene terephthalate, polyvinylchloride, ABS, polystyrene, polymethylmethacrylate, polyurethane, polyacrylate, polymethacrylate, and polysiloxane, aromatic copolyimide, polyalpholefins, polythiophene, polyaniline, polypyrrole, polyacetylene, polyisocyanurates, and derivatives thereof, vinyl monomers, styrene, vinyl pyridines, N-vinyl pyrrolidone, vinyl acetate, acrylonitrile, methyl vinyl ketone, methyl methacrylate, methyl acrylate, 2-hydroxyethyl methacrylate, 2-hydroxyethyl acrylate; polyols, ethylene glycol, 1,6-hexane diol, 1,4-cyclohexanedicarbinol, polyamines, 1,6-hexadiamine, 4,4′-methylenebis (N-methylaniline), polycarboxylic acids, adipic acid, phthalic acid, epoxides, ethylene oxide, propylene oxide, and cyclohexene oxide, polyalkylene glycols, polyethylene glycol, polypropylene glycol, vinyl polymers, polystyrene, polyvinyl acetate, polyvinylpyrrolidone, polyvinylpyridine, polymethyl methacrylate, organic liquid-soluble polysaccharides, functionalized polysaccharides, cellulose acetate, and crosslinked swellable polysaccharides.

18) The composition of claim 16 wherein the carrier medium further comprises a phase change medium selected from the group consisting of salt-hydrates, organic eutectics, clathrate-hydrates, paraffins, hydrocarbons, Fischer-Tropsch hard waxes, inorganic eutectic mixtures, acetamide, methyl fumarate, myristic acid, Glauber's salt, paraffin wax, fatty acids, methyl-esters, methyl palmitate, methyl stearate, mixtures of short-chain acids, capric and lauric acid, coconut fatty acids, propane and methane.

19) The composition of claim 10 wherein the coating is selected from the group consisting of azoles, benzotriazole, tolytriazole, halogen resistant azoles, and substituted derivatives thereof.

20) The composition of claim 19 wherein the azole is selected from the group comprising of aromatic azoles, diazoles, triazoles, tetrazoles, benzotriazole, tolyltriazole, 2,5-(aminopentyl) benzimidazole, alkoxybenzotriazole, imidazoles, such as oleyl imidazoline, thiazoles, such as mercaptobenzothiazole, 1-phenyl-5-mercaptotetrazole, thiodiazoles, halogen-resistant azoles, 5,6-dimethyl-benzotriazole; 5,6-diphenylbenzotriazole; 5-benzoyl-benzotriazole; 5-benzyl-benzotriazole and 5-phenyl-benzotriazole, a combination of alkoxybenzotriazole, mercaptobenzothiazole, tolyltriazole, benzotriazole, a substituted benzotriazole, and/or 1-phenyl-5-mercaptotetrazole, a mixture of a pentane-soluble imidazoline, a pentane-soluble amide, a pyridine-based compound, a pentane-soluble dispersant, and a solvent, and combinations thereof.

21) The composition of claim 10 wherein the coating further comprises an inorganic corrosion inhibitor compound.

22) The composition of claim 10 wherein powder is a carbon powder and the coating further comprises a lignin-based compound, ethylene oxide/propylene oxide (EO/PO) block copolymers, anionic surfactants, ionic surfactants and nonionic surfactants.

23) The composition of claim 10 wherein powder selected from the group of aluminum and aluminum alloys and the coating further comprises a cerium compound.

24) The composition of claim 10 wherein the powder is selected from the group of copper, silver, iron, steel and alloys thereof and the coating is selected from the group of mercapto-substituted thiodiazoles, amino-substituted thiodiazoles, and mercapto-substituted triazole, amino-substituted triazoles, oleyl imidazoline, triethanolamine and monoethanolamine.

25) The composition of claim 22 wherein the lignin-based compound further comprises at least one of a monovalent salt of lignin, free acid lignin, polyvalent metal salts of lignin, lignin sulfonic acid, alkali metal salts of lignin sulfonic acid, alkaline earth metal salts of lignin sulfonic acid, and ammonium salts of lignin sulfonic acid.

26) The composition of claim 10 wherein the powder is a carbon powder and the coating is selected from the group of alkali metal salts, alkali earth metal salts, ammonium salts, and alkyl ether phosphates.

27) A process for transferring electrons between cathode, an electron source, and anode, an electron sink, comprising the step of interposing between the cathode and anode an electrically conductive composition comprising a surface-coated powder, the coating imparting improved electrical conductivity properties to the powder relative to uncoated powder.

28) The process of claim 27, further comprising the step of suspending the coated powder in an electrically conductive medium.

29) The process of claim 27, wherein the surface-coated powder is prepared by one of:
complexing a coating compound with powder particles;
adsorbing a coating compound on surfaces of the powder particles; and
imparting a metal coating onto surfaces of powder particles and subsequently complexing the metal coating with another coating.

30) The process of claim 27, wherein the coating compound is in sufficient amount to form at least a molecular monolayer of the coating compound on surfaces of the powder particles.

31) A powder having enhanced thermal and electrical conductivity, produced, in combination a:
powder precursor having average particle sizes in the nanometer to micron size range produced by a process step selected from the group of solubilized, dispersed, emulsified, grinded, spray atomized and vaporized;
coating imparted to the powder precursor particles; and
reaction medium selected from the group of solvents, fluids, monomers, interpolymers, polymers, and phase change materials.

32) The powder of claim 31, wherein the coating imparted to the powder precursor particles further comprises a coating capable of acting as at least one of imparting composition stabilization, corrosion resistance and acting as a dispersant.

33) The process of claim 32, wherein the surface-coated powder precursor is prepared by one of:
complexing a coating compound with powder precursor particles;
adsorbing a coating compound on surfaces of the powder precursor particles; and
organometallic chemistry.

34) The powder of claim 31, wherein the powder is prepared with in situ complexing of coating compound on powder precursor particles.

35) A in situ complexing of coating compound on powder precursor particles is prepared by one of:
microemulsions and chemical reduction of pre-complexed metal salts;
microemulsions and reduction of pre-complexed metal salts using sonochemistry;
sonochemistry using high or ultrahigh frequency acoustic wave generation of cavitation in reaction vessel for reduction of pre-complexed metal salts;
sonochemistry using high or ultrahigh frequency acoustic wave generation of cavitation onto plating surface through plating by electroless deposition of pre-complexed metal salts;
sonochemistry using high or ultrahigh frequency acoustic wave generation of cavitation onto plating surface through plating deposition by electrolysis of pre-complexed metal salts;
sonochemistry using high or ultrahigh frequency acoustic wave generation of cavitation onto plating surface through plating deposition by electrolysis of pre-complexed metal salts using high frequency electrical power source;
submicron atomization of pre-complexed metal salts in liquid carrier with in situ chemical reduction;
submicron atomization of pre-complexed metal salts in liquid carrier with in situ electrochemical reduction;
submicron atomization of pre-complexed metal salts in liquid carrier within vessel with voltage potential between atomizer and cathode;
plasma processing of powder precursor with quenching in liquid carrier having pre-solubilized complexing coating compound;
combustion synthesis processing of powder precursor with quenching in liquid carrier having pre-solubilized complexing coating compound;
pre-complexed powder precursor dissolved in supercritical fluid with in situ chemical reduction;
pre-complexed powder precursor dissolved in supercritical fluid with in situ electrochemical reduction;
electrolysis of pre-complexed metal salts using high frequency electrical power source on anode and cathode;
electrolysis of pre-complexed metal salts using electrically conductive material selected from group of electrolyte or conductive polymer;
high pressure hydrogen chemical reduction reaction of powder precursor in liquid carrier having pre-solubilized complexing coating compound;
high pressure hydrogen chemical reduction reaction of powder precursor in liquid carrier having pre-solubilized complexing coating compound in combination with high or ultrahigh frequency acoustic wave generation of cavitation in reaction vessel;
high pressure hydrogen chemical reduction reaction of powder precursor in liquid carrier having pre-solubilized complexing coating compound in combination with high or ultrahigh frequency electromagnetic force generation in reaction vessel;
cryogenic embrittlement in combination with processes selected from the group of high pressure hydrogen embrittlement, or high|ultrahigh frequency acoustic wave generation of cavitation in reaction vessel; or
electrodialysis of pre-complexed metal salts in combination with processes selected from the group of high pressure hydrogen embrittlement, or high|ultrahigh frequency acoustic wave generation of cavitation on cathode.
